(19) United States
(12) Patent Application Publication
(10) Pub. No.: US 2026/0070033 A1
(43) Pub. Date: Mar. 12, 2026

(54) HEAT EXCHANGER AND TUBESHEET FOR USE IN UREA PRODUCTION

(71) Applicants: DMC GLOBAL INC., Broomfield, CO (US); YARA INTERNATIONAL ASA, Oslo (NO)

(72) Inventors: Mukesh Mohinder Singh AHLAVADI, Perpignan (FR); Lino Giovanni PORRO, Etterbeek (BE); Giulio PACI, Narni (IT)

(21) Appl. No.: 19/320,880

(22) Filed: Sep. 5, 2025

Related U.S. Application Data
(60) Provisional application No. 63/691,986, filed on Sep. 6, 2024.

(51) Int. Cl. B01J 19/00

(52) U.S. Cl. CPC B01J 19/0013; B01J 2219/00092; B01J 2219/00096; B01J 2219/00103

(57) ABSTRACT

A heat exchanger for use in a urea production system may include a first chamber, a second chamber adjacent to the first chamber, a first tubesheet provided between the first chamber and the second chamber, a first plurality of holes provided in the tubesheet, and a plurality of tubes in fluid communication with the first chamber and extending through the second chamber. The second chamber may be sealed from the first chamber. The first tubesheet may include a first base layer and a first clad layer explosively welded to the first base layer. The first base layer may include a first carbon steel. The first clad layer may include a stainless steel alloy, a austenitic stainless steel, a superaustenitic stainless steel, a duplex stainless steel, or a super-duplex steel stainless steel. The heat exchanger may be configured for use in at least one step in a urea production process.

### This application claims priority to United States Provisional Ser. No. 63/691,986 filed Sep. 6, 2024, the entire contents of which are incorporated herein by reference.

Urea is a widely produced nitrogen-based fertilizer, and it is primarily synthesized through the reaction of ammonia (NH₃) and carbon dioxide. Industrial production of urea may typically use two main reactions: the formation of ammonium carbamate as an intermediate, and its subsequent dehydration to form urea. These reactions are exothermic and reversible, requiring precise thermal and pressure control to maximize conversion efficiency and minimize formation of byproducts.

One important issue in industrial urea production is effective management of heat generated and consumed during the various reactions. Accordingly, heat exchangers may play a key role in urea production by facilitating the recovery and redistribution of thermal energy across various stages of the process. For example, heat exchangers may be used to preheat feedstocks, recover heat from reactor effluents, condense process vapors, and/or optimize the thermal integration of the overall system. Efficient heat exchange can improve the energy efficiency of a urea production facility and also enhance yield and stability of the process by maintaining appropriate temperature conditions.

Shell-and-tube heat exchangers may be used in urea production due to their robustness and ability to withstand the pressures and corrosive components used in urea production. However, the harsh operating environment of urea production may pose challenges in terms of equipment design, maintenance, and durability. For example, tubesheets within the heat exchangers may be exposed to temperatures, pressures, and corrosive reagents that can damage and degrade the tubesheets over time. Efforts have been made to produce tubesheets with protective layers to enhance longevity of the components. For example, US Pat. No. 9,435,589, issued on Sep. 6, 2016 describes in part a tubesheet manufactured from a carbon steel material grade and including protective layers of an austenitic-ferritic duplex stainless steel grade.

Such protective layers may be applied using weld overlay techniques, in which the protective layer alloy is deposited onto a face of the base layer. The protective layer is then melted and fused with the base layer, i.e., fusion welded, creating a metallurgical bond between the protective layer and the base layer. However, weld overlay methods may result in surface imperfections, caused by the heat input created during the weld overlay process, that expose the tubesheet to corrosion.

Accordingly, it may be desirable to develop more durable, reliable, and efficient solutions for the production of a tubesheet that can be used within heat exchangers in an industrial urea production process.

### BRIEF SUMMARY

In an exemplary embodiment, a heat exchanger for use in a urea production system may include a first chamber, a second chamber adjacent to the first chamber, a first tubesheet provided between the first chamber and the second chamber, a first plurality of holes provided in the tubesheet, and a plurality of tubes in fluid communication with the first chamber and extending through the second chamber. The second chamber may be sealed from the first chamber. the first tubesheet may include a first base layer having a first base layer surface and a first clad layer explosively welded to the first base layer surface. The first base layer may include a first carbon steel. The first clad layer may include a stainless steel alloy, a first austenitic stainless steel, a first superaustenitic stainless steel, a first duplex stainless steel, or a first super-duplex steel stainless steel. The heat exchanger may be configured for use in at least one step in a urea production process.

In an exemplary embodiment, urea production system may include a urea reactor and a heat exchanger in fluid communication with the urea reactor. The heat exchanger may include a first chamber, a second chamber adjacent to the first chamber, a first tubesheet provided between the first chamber and the second chamber, a first plurality of holes provided in the tubesheet, and a plurality of tubes in fluid communication with the first chamber and extending through the second chamber. The second chamber may be sealed from the first chamber. The first tubesheet may include a first base layer having a first base layer surface and a first clad layer explosively welded to the first base layer surface. The first base layer may include carbon steel. The first clad layer may include a first austenitic stainless steel, a first superaustenitic stainless steel, a first duplex stainless steel, or a first super-duplex steel stainless steel.

### BRIEF DESCRIPTION OF THE SEVERAL VIEWS OF THE DRAWINGS

A more particular description will be rendered by reference to exemplary embodiments that are illustrated in the accompanying figures. Understanding that these drawings depict exemplary embodiments and do not limit the scope of this disclosure, the exemplary embodiments will be described and explained with additional specificity and detail by the accompanying drawings in which:

FIG. 1 is a cross-section schematic of a horizontally oriented heat exchanger according to an exemplary embodiment;

FIG. 2 is a cross-section schematic of a vertically oriented heat exchanger according to an exemplary embodiment;

FIG. 3 is a plan view of a tubesheet according to an exemplary embodiment;

FIG. 4A illustrates formation of a tubesheet according to an exemplary embodiment;

FIG. 4B is a cross-section view of a manufacturing step of a tubesheet according to an exemplary embodiment;

FIG. 5 is a schematic drawing of a system for use in urea production according to an exemplary embodiment;

FIG. 6 is a schematic drawing of a system for use in urea production according to an exemplary embodiment; and

FIG. 7 is an explanatory schematic diagram showing steps of preparing a cladded article through explosive welding.

Various features, aspects, and advantages of the exemplary embodiments will become more apparent from the following detailed description, along with the accompanying drawings in which like numerals represent like components throughout the figures and detailed description. The various described features are not necessarily drawn to scale in the drawings but are drawn to aid in understanding the features of the exemplary embodiments.

The headings used herein are for organizational purposes only and are not meant to limit the scope of the disclosure or the claims. To facilitate understanding, reference numerals have been used, where possible, to designate like elements common to the figures.

### DETAILED DESCRIPTION

Reference will now be made in detail to various exemplary embodiments. Each example is provided by way of explanation and is not meant as a limitation and does not constitute a definition of all possible embodiments. It is understood that reference to a particular “exemplary embodiment” of, e.g., a structure, assembly, component, configuration, method, etc. includes exemplary embodiments of, e.g., the associated features, subcomponents, method steps, etc. forming a part of the “exemplary embodiment.”

For purposes of this disclosure, the phrases “devices,” “systems,” and “methods” may be used either individually or in any combination referring without limitation to disclosed components, grouping, arrangements, steps, functions, or processes.

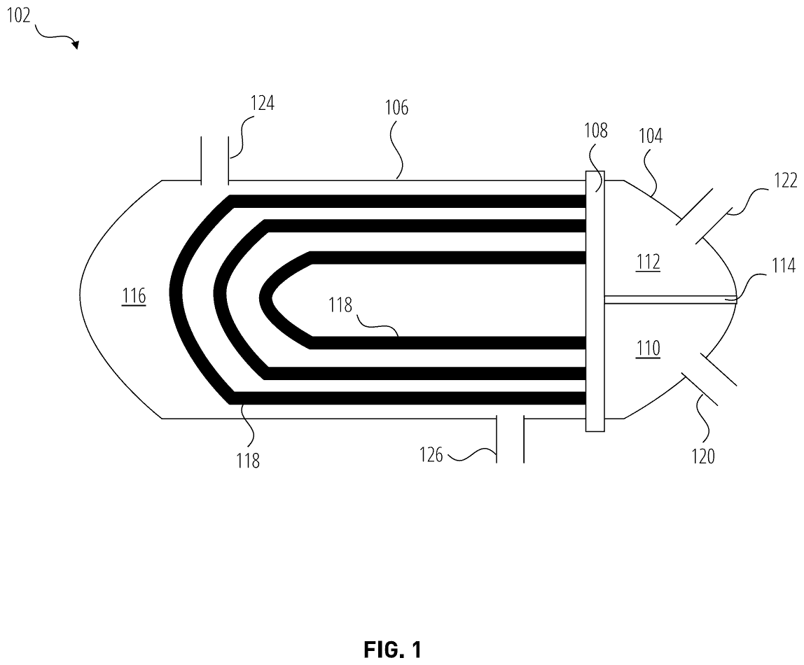

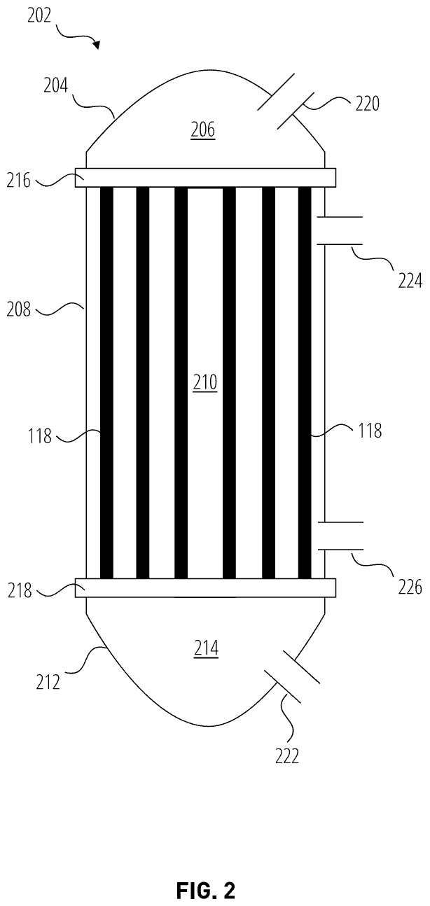

Shell-and-tube heat exchangers may be oriented horizontally or vertically. Additionally, shell-and-tube heat exchangers may be described in terms of tube-side flow and shell-side flow. Tube-side flow refers to fluids that flow within the tubes of the heat-exchanger and/or compartments in fluid communication with the tubes. Shell-side flow refers to fluids that flow within the shell in a space surrounding the tubes. These concepts will be explained in detail below with reference to FIG. 1 and FIG. 2. A shell-and-tube heat exchanger may be configured for use in at least one step in a urea production process as described below.

FIG. 1 shows an exemplary embodiment of a horizontally-oriented shell-and-tube heat exchanger 102. The heat exchanger 102 may include a tube-side body 104 and a shell-side body 106, with a tubesheet 108 interposed between the tube-side body 104 and the shell-side body 106. While FIG. 1 shows the tube-side body 104 and the shell-side body 106 defining chambers of the heat exchanger, the structure is not limited to this embodiment; for example, the tube-side body 104 may be embodied as tubes or channels connected directly to the tubesheet.

The tube-side body 104 and the tubesheet 108 may define a cavity that is divided into a first tube-side chamber 110 and a second tube-side chamber 112 by a divider 114 such that the first tube-side chamber 110 is sealed from direct contact with the second tube-side chamber 112 (fluid communication between the first tube-side chamber 110 and the second tube-side chamber 112 can still occur via tubes tube 118 as described in detail below). The shell-side body 106 and the tubesheet 108 may define a shell-side chamber 116. In an exemplary embodiment, the first tube-side chamber 110 may be considered to be a first chamber, the shell-side chamber 116 may be considered to be a second chamber adjacent to the first chamber, and the second tube-side chamber 112 may be considered to be a third chamber adjacent to the first chamber and the second chamber.

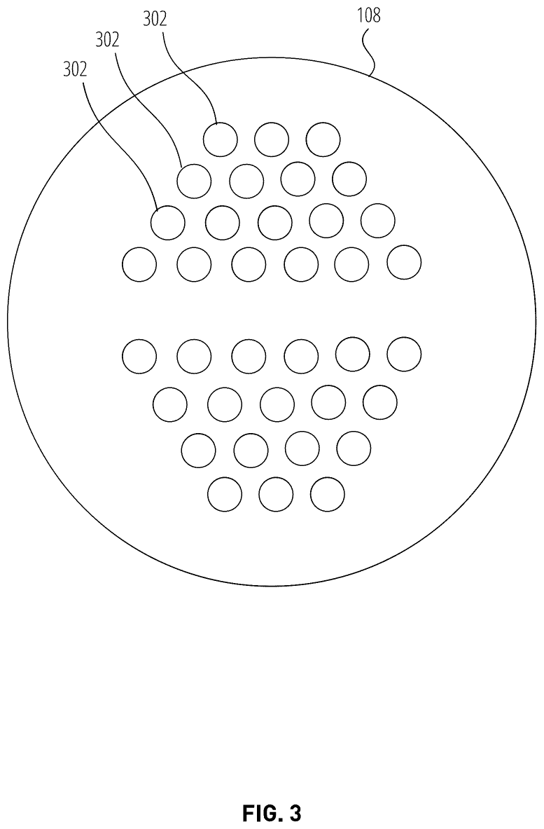

The tubesheet 108 may include a plurality of holes 302 extending through the tubesheet 108 in a thickness direction (see FIG. 3). In an exemplary embodiment, the tubesheet 108 may be corrosion resistant and able to withstand temperatures in a range of 50 to 500 degrees Celsius and pressures in a range of 50 to 500 bars. Typical applications may require a tubesheet 108 having a diameter in a range of 500 mm to 6000 mm. However, it will be understood that the disclosure is not limited to this and larger and/or smaller diameters may also be within the scope of this disclosure.

A plurality of tubes 118 may be provided within the shell-side chamber 116, and ends of the tubes may be inserted into the holes 302 of the tubesheet 108. The plurality of tubes 118 may be sealed to the tubesheet 108 such that there is no fluid communication between the shell-side chamber 116 and an interior of the plurality of tubes 118. In an exemplary embodiment, the plurality of tubes 118 are formed of a thermally conductive material.

The heat exchanger 102 may further include a first tube-side chamber inlet 120 connected to the first tube-side chamber 110 to supply and/or remove a fluid such as a liquid or gas to or from the first tube-side chamber 110. A second tube-side chamber inlet 122 may be connected to the second tube-side chamber 112 to supply and/or remove a fluid such as a liquid or gas to or from the second tube-side chamber 112. Depending on the configuration and operation of the heat exchanger 102, fluid may flow from the first tube-side chamber 110 to the second tube-side chamber 112 through the plurality of tubes 118 or from the second tube-side chamber 112 to the first tube-side chamber 110 through the plurality of tubes 118. Additional inlets may be provided at either of the first tube-side chamber 110 or the second tube-side chamber 112 to facilitate introduction of additional fluids or removal of additional fluids. The flow of fluid(s) through the first tube-side chamber 110, the plurality of tubes 118, and the second tube-side chamber 112 may be referred to as a tube-side flow.

In an exemplary embodiment, a first fluid may be introduced in either of the first tube-side chamber 110 or the second tube-side chamber 112, travel through the plurality of tubes 118, and exit through the other of the first tube-side chamber 110 and the second tube-side chamber 112. Alternatively, a first fluid and a second fluid may be supplied to one of the first tube-side chamber 110 or the second tube-side chamber 112 through the first tube-side chamber inlet 120. The first fluid and the second fluid may flow through the tubes 118 and react with each other, with one or more products flowing through the first tube-side chamber 110 and/or the second tube-side chamber 112.

The heat exchanger 102 may further include a shell-side chamber inlet 124 connected to the shell-side chamber 116 to supply a fluid such as a liquid or gas to the shell-side chamber 116. The second fluid may flow through the shell-side chamber 116 around the tubes 118. The heat exchanger 102 may further include a shell-side chamber outlet 126 connected to the shell-side chamber 116 to provide a path for the second fluid to leave the shell-side chamber 116. It will be understood that the shell-side chamber inlet 124 and the shell-side chamber outlet 126 are not limited to the configuration shown in FIG. 1. For example, the shell-side chamber inlet 124 and the shell-side chamber outlet 126 may be swapped in position or provided in different positions on the shell-side body 106. Further, additional inlets and/or outlets may be connected to the shell-side chamber 116 to facilitate introduction and/or removal of additional fluids. The fluid(s) in the shell-side chamber 116 may circulate through the shell-side chamber 116 and exchange heat energy with the fluid(s) passing through the plurality of tubes 118. The circulation of the fluid through the shell-side chamber 116 may be referred to as a shell-side flow.

FIG. 2 shows an exemplary embodiment of a vertically-oriented shell-and-tube heat exchanger 202. The heat exchanger 202 may include a first tube-side body 204 defining a first tube-side chamber 206, a shell-side body 208 defining a shell-side chamber 210, and a second tube-side body 212 defining a second tube-side chamber 214. The shell-side chamber 210 may be provided between the first tube-side chamber 206 and the second tube-side chamber 214. In other words, the first tube-side chamber 206 may be considered to be a first chamber, the shell-side chamber 210 may be considered to be a second chamber, and the second tube-side chamber 214 may be considered to be a third chamber, with the second chamber being provided between the first chamber and the second chamber. While FIG. 2 shows the first tube-side body 204 and the second tube-side body 210 defining chambers of the heat exchanger, the structure is not limited to this embodiment; for example, the first tube-side body 204 and the second tube-side body 210 may be embodied as channels or tubes connected directly to a first tubesheet 216 and/or the second tubesheet 218 of the heat exchanger 202.

The first tubesheet 216 may be provided between the first tube-side chamber 206 and the shell-side chamber 210, and the second tubesheet 218 may be provided between the shell-side chamber 210 and the second tube-side chamber 214. The first tubesheet 216 and the second tubesheet 218 may include a plurality of holes 302 extending through each of the first tubesheet 216 and the second tubesheet 218 in a thickness direction (see FIG. 3). A plurality of tubes 118 may be provided within the shell-side chamber 210. First ends of the plurality of tubes 118 may be inserted into the holes 302 of the first tubesheet 216, and second ends of the plurality of tubes 118 may be inserted into the holes 302 of the second tubesheet 218. The plurality of tubes 118 may be sealed to the first tubesheet 216 and the second tubesheet 218 such that there is no fluid communication between the shell-side chamber 210 and the interior of the tubes 118. The plurality of tubes 118 may be formed of a thermally conductive material.

The heat exchanger 202 may further include a first tube-side chamber inlet 220 connected to the first tube-side chamber 206 to supply and/or remove a fluid such as a liquid or gas to the first tube-side chamber 206. A second tube-side chamber inlet 222 may be connected to the second tube-side chamber 214 to supply and/or remove a fluid such as a liquid or gas to the second tube-side chamber 214.

In an exemplary embodiment, a first fluid may be introduced at one of the first tube-side chamber inlet 220 and the second tube-side chamber inlet 222, travel through the plurality of tubes 118, and exit through the other of the first tube-side chamber inlet 220 and the second tube-side chamber inlet 222. Alternatively, a first fluid may be supplied to the first tube-side chamber 206 through the first tube-side chamber inlet 220, and a second fluid may be supplied to the second tube-side chamber 214 through the second tube-side chamber inlet 222. The first fluid and the second fluid may flow through the plurality of tubes 118 and react with each other, with product(s) falling back to the second tube-side chamber 214 and exiting through the second tube-side chamber inlet 222 and/or rising to the first tube-side chamber 206 and exiting through the first tube-side chamber inlet 220. It will be understood that the heat exchanger 202 is not limited to a single first tube-side chamber inlet 220 and/or a single second tube-side chamber inlet 222. Additional inlets may be provided to accommodate additional reagents and/or products being supplied to and/or removed from the heat exchanger 202.

The heat exchanger 202 may further include a shell-side chamber inlet 224 connected to the shell-side chamber 210 and a shell-side chamber outlet 226 connected to the shell-side chamber 210. The shell-side chamber inlet 224 and the shell-side chamber outlet 226 may facilitate the circulation of a shell-side fluid through the shell-side chamber 210 and around the plurality of tubes 118. The shell-side fluid may may circulate through the shell-side chamber 210 and exchange heat energy with one or more tube-side fluids passing through the plurality of tubes 118. It will be understood that the heat exchanger 202 is not limited to a single shell-side chamber inlet 224 and/or a single shell-side chamber outlet 226. For example, additional inlets and/or outlets may be provided to allow for additional reagents to be supplied to the shell-side chamber 210 and/or additional products to be removed from the shell-side chamber 210.

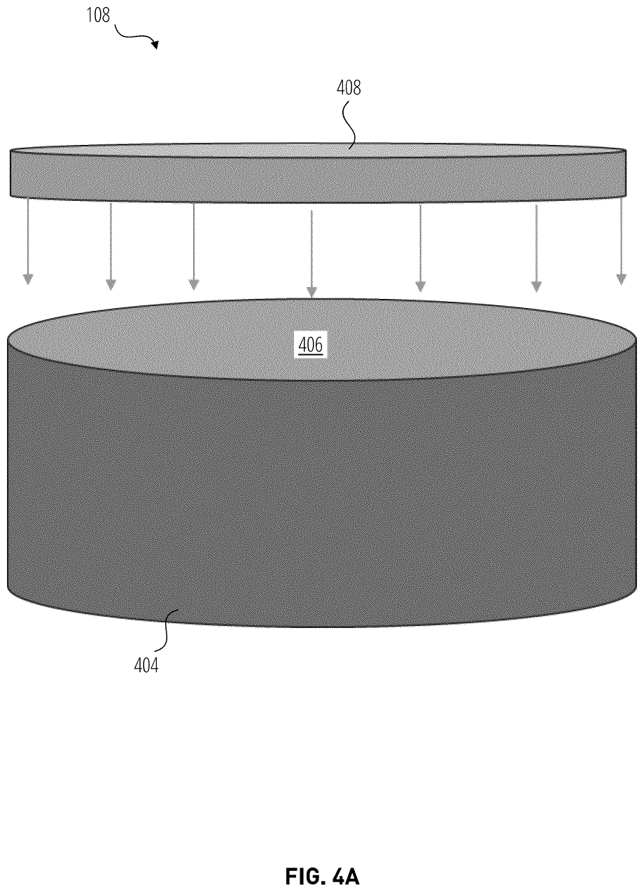

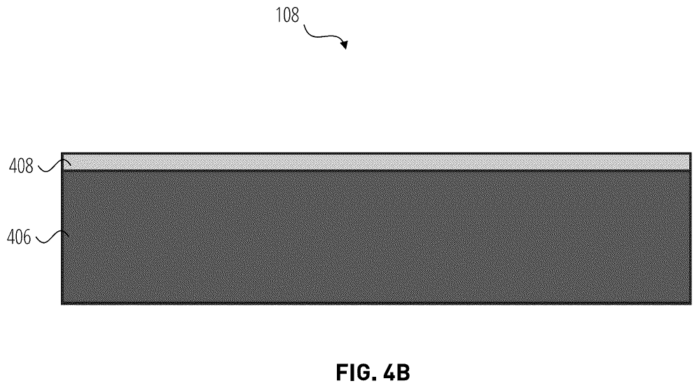

FIG. 4A shows an exemplary embodiment of a step in the formation of the tubesheet 108. The tubesheet 108 may include a base layer 404 having a first base layer surface 406. In an exemplary embodiment, the base layer 404 may have a thickness of approximately 200 mm, though it will be understood that the disclosure is not limited to this thickness. For example, in an exemplary embodiment, the base layer 404 may have a thickness in a range of approximately 200 mm to approximately 1000 mm. In a further exemplary embodiment, the base layer 404 may have a thickness in a range of approximately 300 mm to approximately 900 mm. In a further exemplary embodiment, the base layer 404 may have a thickness in a range of approximately 600 mm to approximately 700 mm.

The base layer 404 may be formed of a steel or steel alloy. In an exemplary embodiment, the base layer 404 of the tubesheet 108 may include carbon steel. The carbon steel may have a carbon content of 0.20-0.30 % and a manganese content of 0.60-1.35 %. The carbon steel may be an alloy such as SA 266 Gr 2 or SA 266, but it will be understood that the disclosure is not limited to these alloys.

The tubesheet 108 may further include a first clad layer 408 joined to the first base layer surface 406. In an exemplary embodiment, the first clad layer 408 may be explosively welded (i.e., explosion cladded) to the first base layer surface 406. In an exemplary embodiment, the clad layer 408 consists of one and only one clad layer, i.e., a single clad layer. The first clad layer 408 may be formed of a steel or steel alloy. In an exemplary embodiment the first clad layer 408 may include a stainless steel. In an exemplary embodiment, the first clad layer 408 may include one or more of an austenitic stainless steel, a superaustenitic stainless steel, a duplex stainless steel, or a super-duplex stainless steel. For example, the first clad layer 408 may include Safurex® super-duplex stainless steel provided by Stamicarbon, Uremium29™ super-duplex stainless steel provided by Tubacex/Casale, DMC 2907, 25Cr22Ni2Mo (alloy 25/22/2), UNS 310MoLN, SAF™ 2906 provided by Alleima, DP28W™ duplex stainless steel provided by Sumitomo Metal Industries and Toyo Engineering Corporation, DMV2907, or Saturn31™ super-duplex stainless steel provided by Tubacex, but it will be understood that the disclosure is not limited to these examples. In an exemplary embodiment, the first clad layer 408 may include an austenitic-ferritic stainless steel comprising approximately 30-70% ferrite by microstructure phase volume, and weight composition of approximately 28-35% chromium, approximately 3-10% nickel, approximately 1-4% molybdenum, approximately 0-0.05% carbon, and approximately 0.2-0.6% nitrogen. In an exemplary embodiment, the first clad layer 408 may include a fully austenitic stainless steel having a weight composition of approximately 45-55% iron, approximately 24-26% chromium, approximately 21-23% nickel, approximately 2-3% molybdenum, approximately 0-0.03% carbon, and approximately 0.1-0.16% nitrogen. In an exemplary embodiment, the first clad layer 408 may have a thickness in a range of 6 to 25 mm, though it will be understood that the disclosure it not limited to this thickness.

Once the first clad layer 408 is explosively welded to the base layer 404, the holes 302 may be machined in the tubesheet 108.

FIG. 4B shows that the first clad layer 416 has been explosively welded to the base layer 410. When prepared, the first clad layer 416 may have a thickness in a range of 6 mm to 25 mm.

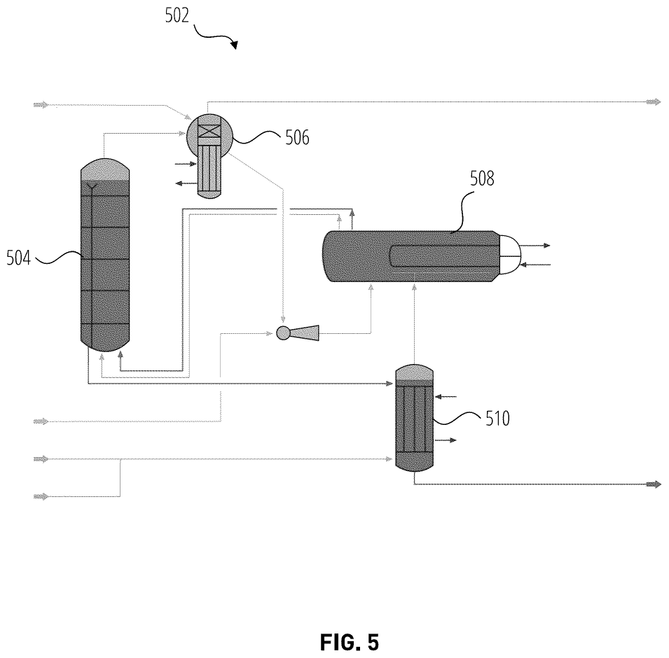

FIG. 5 shows an exemplary embodiment of a system 502 for use in industrial urea production. The system 502 may include a reactor 504, a scrubber 506, a pool condenser 508, and a stripper 510 in mutual fluid communication with each other. The reactor 504 may be a urea reactor configured to produce urea. In an exemplary embodiment, a liquid/vapor separation may be performed at a top of the reactor 504. Vapors from the reactor 504 may be sent to the scrubber 506. These gases may include ammonia, carbon dioxide, water, and/or inert gases.

The scrubber 506 may be a vertically-oriented heat exchanger (see, e.g. FIG. 2 for an exemplary embodiment of a vertically-oriented heat exchanger). The tube-side flow of the scrubber 506 may include vapors fed from a bottom of the scrubber 506 and a carbamate solution fed from a top of the scrubber 506. Cooling water may be circulated as the shell-side flow of the scrubber 506. As a vertically-oriented heat exchanger, the scrubber 506 may include two tubesheets. In the context of the scrubber 506, the ammonium carbamate in the tube-side flow is highly corrosive and supplied at high temperature and high pressure.

Accordingly, the tubesheets of the scrubber 506 may be configured so that the clad layer faces the tube-side flow of the scrubber 506.

The pool condenser 508 may be a horizontally-oriented heat exchanger (see, e.g., FIG. 1 for an exemplary embodiment of a horizontally-oriented heat exchanger). The shell-side flow of the pool condenser 508 may include vapor and carbamate solution, and the tube-side flow of the pool condenser 508 may include steam condensate. The tube-side flow of the pool condenser 508 may remove heat from shell-side flow of the pool condenser 508 and produce steam as an output, at a pressure of 300 kPa to 900 kPa (i.e., 3 bar to 9 bar). The tubes of the pool condenser 508 may be U-shaped tubes, with one tubesheet. In the context of the pool condenser 508, the shell-side flow includes a carbamate solution that may be highly corrosive. Accordingly, the tubesheets of the pool condenser 508 may be configured so that the clad layer faces the shell-side flow of the pool condenser 508.

The stripper 510 may be a vertically-oriented heat exchanger (see, e.g. FIG. 2 for an exemplary embodiment of a vertically-oriented heat exchanger). The tube-side flow of the stripper 510 may include an aqueous solution comprising urea, ammonium carbamate, and free ammonia produced by the reactor 504 and fed to the top of the stripper 510. In some technologies the tube-side flow of the stripper 510 may include a gaseous flow of carbon dioxide fed to the bottom of stripper 510. Gaseous flow of carbon dioxide will flow from the bottom to the top, countercurrent with the aqueous solution. In other technologies the flow of carbon dioxide may not be present. The shell-side flow of the stripper 510 may include steam at a pressure of 1500 kPA to 2600 kPa (i.e., 15 bar to 26 bar). The aqueous solution in the tube-side flow may be heated with steam to decompose the ammonium carbamate into ammonia and carbon dioxide. As a vertically-oriented heat exchanger, the stripper 510 may include two tubesheets. In the context of the stripper 510, the tube-side flow includes reagents that may be highly corrosive. Accordingly, the tubesheets of the stripper 510 may be configured so that the clad layer faces the tube-side flow of the stripper 510.

The tubesheets of the scrubber 506, the pool condenser 508, and/or the stripper 510 may have a base layer formed of carbon steel. A clad layer of the tubesheets may be formed of a superaustenitic stainless steel such as alloy 25/22/2, i.e., a stainless steel having approximately 25% chromium, approximately 22% nickel, and approximately 2% molybdenum. Alternatively, the clad layer may be formed of a super-duplex stainless steel, more specifically, the clad layer may be formed of SAF^{TM} 2906 super-duplex stainless steel (approximately 29% chromium, approximately 7% nickel, approximately 2.3% molybdenum), Safurex® super-duplex stainless steel, DP28W™ duplex stainless steel, or Saturn31™ super-duplex stainless steel.

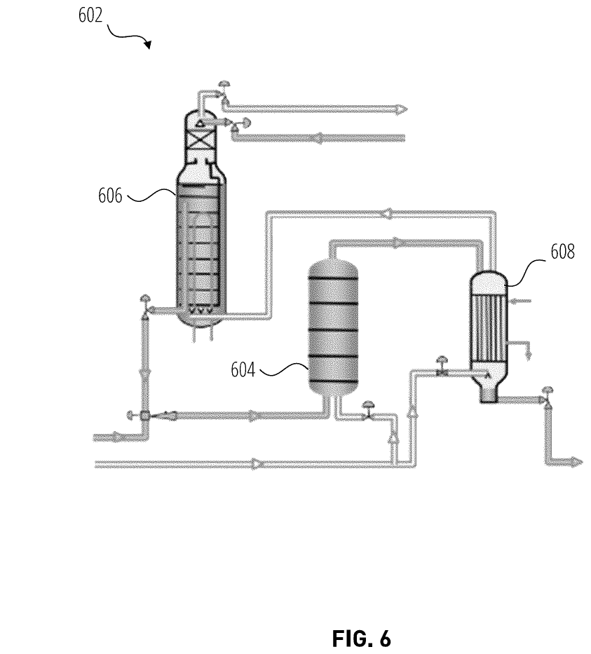

FIG. 6 shows an exemplary embodiment of a system 602 for use in industrial urea production. The system 602 may include a reactor 604, a vertical submerged carbamate condenser 606, and a stripper 608 in mutual fluid communication with each other. The stripper 608 may be similar to the stripper 510 described above with reference to FIG. 5.

The vertical submerged carbamate condenser 606 may be a vertical submerged carbamate condenser configured as a vertically-oriented heat exchanger with U-shaped tubes and a single tubesheet. The shell-side flow of the carbamate condenser 606 may include vapor and carbamate solution moving from a bottom of the shell to a top of the shell, with the vapors condensing into carbamate. The tube-side flow of the carbamate condenser 606 may include steam condensate. The tube-side flow of the carbamate condenser 606 may remove heat from the tube-side flow and produce steam at a pressure of 300 kPa to 900 kPa (i.e., 3 bar to 9 bar). In the context of the carbamate condenser 606, the shell-side flow includes a carbamate solution that may be highly corrosive. Accordingly, the tubesheet of the carbamate condenser 606 may be configured so that the clad layer faces the shell-side flow of the carbamate condenser 606.

The tubesheets of the vertical submerged carbamate condenser 606 and/or the stripper 608 may have a base layer formed of carbon steel. A clad layer of the tubesheets may be formed of a superaustenitic stainless steel such as alloy 25/22/2, i.e., a stainless steel having approximately 25% chromium, approximately 22% nickel, and approximately 2% molybdenum. Alternatively, the clad layer may be formed of a duplex steel or a super-duplex steel, more specifically, the clad layer may be formed of a super-duplex steel such as SAF™ 2906 (approximately 29% chromium, approximately 7% nickel, approximately 2.3% molybdenum), Safurex® super-duplex stainless steel, DP28W™ duplex stainless steel, or Saturn31™ super-duplex stainless steel.

As an alternative to the pool condenser 508 and the vertical submerged carbamate condenser 606 described above, a system for urea production may include a kettle carbamate condenser or a falling film carbamate condenser. A kettle carbamate condenser may be a horizontally-oriented heat exchanger (see FIG. 1,), with the tube-side flow including a mix of vapor and carbamate solution and the shell-side flow including a steam condensate. The shell-side flow may produce steam at a pressure of 300 kPa to 900 kPa (i.e., 3 bar to 9 bar). A kettle carbamate condenser may use U-shaped tubes and one tubesheet. The tubesheet may be constructed similar to the tubesheets described above for the pool condenser 508 and/or the vertical submerged carbamate condenser 606. The tubesheet may be configured such that the clad layer faces the tube-side flow of the kettle-type carbamate condenser.

A falling film-type carbamate condenser may include a vertically-oriented heat exchanger. The tube-side flow may include vapor and carbamate solution supplied to a top of the falling film carbamate condenser. The carbamate solution may flow down as a falling film through the tubes, with vapors condensing on the surface of the falling film. The shell-side flow may include steam condensate to produce steam at a pressure of 300 kPa to 900 kPa (i.e., 3 bar to 9 bar). A falling film carbamate condenser may use straight tubes, thus requiring two tubesheets. The tubesheets may be constructed similar to the tubesheets described above for the pool condenser 508 and/or the vertical submerged carbamate condenser 606. The tubesheets may be configured such that the clad layer faces the tube-side flow of the falling film-type carbamate condenser.

While FIG. 5 and FIG. 6 have been presented as examples of urea production systems, it will be understood that the tubesheets described herein are not limited to these specific urea production systems. It will be understood that there are many possible different configurations for industrial urea production in which the tubesheets described herein may be used.

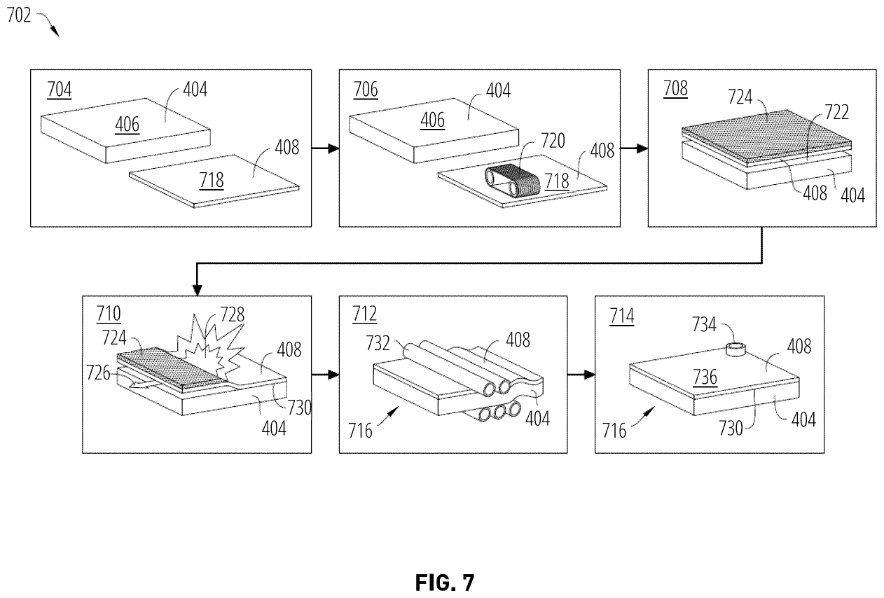

FIG. 7 shows an exemplary embodiment of a method 702 for explosively welding, i.e., explosion cladding, a base layer 404 with a first clad layer 408 to generate a cladded article 716 used for the preparation of the tubesheets and other products described in various embodiments above. In block 704, the base layer 404 and the first clad layer 408 are separately prepared and inspected. In an exemplary embodiment, the base layer 404 and the first clad layer 408 may be prepared as substantially flat sheets or plates. It will be noted that in explosion cladding, it may be important for the first clad layer 408 to have a substantially uniform thickness, otherwise the geometry of forces applied during the explosion cladding may be sub-optimal, resulting in a low-quality weld. In block 706, mating surfaces of the base layer 404 and the first clad layer 408, i.e., a first base layer surface 406 and a first clad layer surface 718, may be ground by a grinder 720. In block 708, the first clad layer 408 may be positioned with the first clad layer surface 718 facing the first base layer surface 406 with a predetermined gap 722 provided therebetween. Explosive material 724 may be layered over the first clad layer 408. In block 710, the explosive material 724 is detonated starting at a first side and progressing to an opposite side as illustrated by arrow 726. The force of the explosion 728 propels the first clad layer 408 against the base layer 404 thereby forming a solid-state welding interface region 730 therebetween. In block 712, rollers 732 may be applied to the cladded article 716 to flatten it if necessary. In block 714, the cladded article typically undergoes quality testing. For example, an ultrasonic probe 734 may be used over an outer surface 736 of the first clad layer 408 to check for high quality bonds between the base layer 404 and the first clad layer 408.

Explosion cladding or explosion welding may provide a number of advantages over conventional fusion welding used in weld overlay techniques. For example, the lack of heat in explosion welding results in a substantially smaller heat-affected zone in the joint, thereby reducing residual stresses, distortion, and alteration of the metals around the joint. Explosion welding also allows for large surface areas to be quickly and uniformly joined together. In contrast, the fusion welding used in weld overlay may result in surface imperfections that increase the risk of corrosion and degradation.

This disclosure, in various embodiments, configurations and aspects, includes components, methods, processes, systems, and/or apparatuses as depicted and described herein, including various embodiments, sub-combinations, and subsets thereof. This disclosure contemplates, in various embodiments, configurations and aspects, the actual or optional use or inclusion of, e.g., components or processes as may be well-known or understood in the art and consistent with this disclosure though not depicted and/or described herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Approximating language, as used herein throughout the specification and claims, may be applied to modify any quantitative representation that could permissibly vary without resulting in a change in the basic function to which it is related. Accordingly, a value modified by a term such as “about” or “approximately” is not to be limited to the precise value specified. Such approximating language may refer to the specific value and/or may include a range of values that may have the same impact or effect as understood by persons of ordinary skill in the art field. For example, approximating language may include a range of +/−10%, +/−5%, or +/−3%. The term “substantially” as used herein is used in the common way understood by persons of skill in the art field with regard to patents, and may in some instances function as approximating language. In some instances, the approximating language may correspond to the precision of an instrument for measuring the value.

In this specification and the claims that follow, reference will be made to a number of terms that have the following meanings. The terms “a” (or “an”) and “the” refer to one or more of that entity, thereby including plural referents unless the context clearly dictates otherwise. As such, the terms “a” (or “an”), “one or more” and “at least one” can be used interchangeably herein. Furthermore, references to “one embodiment”, “some embodiments”, “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur-this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that the appended claims should cover variations in the ranges except where this disclosure makes clear the use of a particular range in certain embodiments.

The terms “determine”, “calculate,” and “compute,” and variations thereof, as used herein, are used interchangeably and include any type of methodology, process, mathematical operation or technique.

This disclosure is presented for purposes of illustration and description. This disclosure is not limited to the form or forms disclosed herein. In the Detailed Description of this disclosure, for example, various features of some exemplary embodiments are grouped together to representatively describe those and other contemplated embodiments, configurations, and aspects, to the extent that including in this disclosure a description of every potential embodiment, variant, and combination of features is not feasible. Thus, the features of the disclosed embodiments, configurations, and aspects may be combined in alternate embodiments, configurations, and aspects not expressly discussed above. For example, the features recited in the following claims lie in less than all features of a single disclosed embodiment, configuration, or aspect. Thus, the following claims are hereby incorporated into this Detailed Description, with each claim standing on its own as a separate embodiment of this disclosure.

Advances in science and technology may provide variations that are not necessarily express in the terminology of this disclosure although the claims would not necessarily exclude these variations.

What is claimed is:

1. A heat exchanger for use in a urea production system, the heat exchanger comprising:
a first chamber;
a second chamber adjacent to the first chamber;
a first tubesheet provided between the first chamber and the second chamber;
a first plurality of holes provided in the tubesheet;
a plurality of tubes in fluid communication with the first chamber and extending through the second chamber;
wherein the second chamber is sealed from the first chamber;
the first tubesheet comprises:
a first base layer having a first base layer surface;
a first clad layer explosively welded to the first base layer surface;
wherein the first base layer comprises a first carbon steel; and
the first clad layer comprises a stainless steel alloy, a first austenitic stainless steel, a first superaustenitic stainless steel, a first duplex stainless steel, or a first super-duplex steel stainless steel; and
the heat exchanger is configured for use in at least one step in a urea production process.

2. The heat exchanger of claim 1, wherein the clad layer faces the first chamber.

3. The heat exchanger of claim 1, wherein the clad layer faces the second chamber.

4. The heat exchanger of claim 1, further comprising:
a third chamber;
wherein the third chamber is sealed from the first chamber; and
the plurality of tubes connects the first chamber and the third chamber such that the first chamber is in fluid communication with the third chamber.

5. The heat exchanger of claim 4, wherein:
the third chamber is adjacent to the first chamber and the second chamber.

6. The heat exchanger of claim 1, wherein the heat exchanger is kettle-type carbamate condenser, a horizontally-oriented heat exchanger, a vertical submerged carbamate condenser, or a pool condenser.

7. The heat exchanger of claim 4, wherein the second chamber is provided between the first chamber and the third chamber.

8. The heat exchanger of claim 7, further comprising:
a second tubesheet provided between the second chamber and the third chamber;
a second plurality of holes provided in the second tubesheet;
wherein each tube of the plurality of tubes extends through the second chamber from a hole of the first plurality of holes in the first tubesheet to a corresponding hole of the second plurality of holes in the second tubesheet; and
the second tubesheet comprises:
a second base layer having a second base layer surface;
a second clad layer explosively welded to the second clad layer surface;
wherein the second base layer comprises a second carbon steel; and
the second clad layer comprises, a second austenitic stainless steel, a second superaustenitic stainless steel, a second duplex stainless steel, or a second super-duplex steel stainless steel.

9. The heat exchanger of claim 1, wherein the heat exchanger is a stripper, a falling film carbamate condenser, or a scrubber.

10. The heat exchanger of claim 1, wherein:
the base layer has a thickness greater than or equal to 200 mm; and
the clad layer has a thickness greater than or equal to 10 mm.

11. A urea production system comprising:
a urea reactor; and
a heat exchanger in fluid communication with the urea reactor;
wherein the heat exchanger comprises:
a first chamber;
a second chamber adjacent to the first chamber;
a first tubesheet provided between the first chamber and the second chamber;
a first plurality of holes provided in the tubesheet;
a plurality of tubes in fluid communication with the first chamber and extending through the second chamber;
wherein the second chamber is sealed from the first chamber; and
the first tubesheet comprises:
a first base layer having a first base layer surface;
a first clad layer explosively welded to the first base layer surface;
wherein the first base layer comprises carbon steel; and
the first clad layer comprises, a first austenitic stainless steel, a first superaustenitic stainless steel, a first duplex stainless steel, or a first super-duplex steel stainless steel.

12. The urea production system of claim 11, wherein the clad layer faces the first chamber.

13. The urea production system of claim 11, wherein the clad layer faces the second chamber.

14. The urea production system of claim 11, wherein the heat exchanger further comprises:
a third chamber;
wherein the third chamber is sealed from the first chamber; and
the plurality of tubes connects the first chamber and the third chamber such that the first chamber is in fluid communication with the third chamber.

15. The urea production system of claim 14, wherein:
the third chamber is adjacent to the first chamber and the second chamber.

16. The heat exchanger of claim 11, wherein the heat exchanger is kettle-type carbamate condenser, a horizontally-oriented heat exchanger, a vertical submerged carbamate condenser, or a pool condenser.

17. The urea production system of claim 15, wherein the second chamber is provided between the first chamber and the second chamber.

18. The urea production system of claim 17, wherein the heat exchanger further comprises:
a second tubesheet provided between the second chamber and the third chamber;
a second plurality of holes provided in the second tubesheet;
wherein each tube of the plurality of tubes extends through the second chamber from a hole of the first plurality of holes in the first tubesheet to a corresponding hole of the second plurality of holes in the second tubesheet; and
the second tubesheet comprises:
a second base layer having a second base layer surface;
a second clad layer explosively welded to the second clad layer surface;
wherein the second base layer comprises carbon steel; and
the second clad layer comprises, a second austenitic stainless steel, a second superaustenitic stainless steel, a second duplex stainless steel, or a second super-duplex steel stainless steel.

19. The urea production system of claim 14, wherein the heat exchanger is a stripper, a falling film carbamate condenser, or a scrubber.

20. The urea production system of claim 11, wherein
the base layer has a thickness greater than or equal to 200 mm; and
the clad layer has a thickness greater than or equal to 10 mm.
